(19) United States
(12) Patent Application Publication
(10) Pub. No.: US 2025/0181054 A1
(43) Pub. Date: Jun. 5, 2025

(54) OPTIMISATION OF NUMERIC CONTROL OF A MACHINE TOOL

(71) Applicant: Fill Gesellschaft m.b.H., Gurten (AT)

(72) Inventors: Verena Stanzl, Krems (AT); Michael Gillhofer, Linz (AT); Stefan Murauer, Ried im Innkreis (AT)

(21) Appl. No.: 18/868,660

(22) PCT Filed: May 22, 2023
(86) PCT No.: PCT/AT2023/060163

§ 371 Date: Nov. 22, 2024

(30) Foreign Application Priority Data
May 23, 2022 (AT) A50360/2022

(51) Int. Cl. G05B 19/4093

(52) U.S. Cl. CPC G05B 19/40931; G05B 2219/32335; G05B 2219/49066

(57) ABSTRACT

A computer-implemented method for optimizing a numerical control of a machine tool having a tool for machining a workpiece may include obtaining numerical tool information with respect to a machining. The method may further include acquiring, by a trained neural network, timing information based on the obtained tool information and generating a set of path information for machining from the timing information and the tool information. The set of path information may include a travel path of the tool, which may include an approach, tool entry, working, and tool exit phase, and a distance between the tool and the workpiece before the approach phase. The method may include determining a minimum distance between the tool and the workpiece before the approach phase from a plurality of sets of path information of a plurality of previous machinings for a next machining.

### CROSS-REFERENCE TO RELATED APPLICATIONS

This application claims priority to International Patent Application No. PCT/AT2023/060163, filed on May 22, 2023, and Austrian Patent Application No. A50360/2022, filed on May 23, 2022, the contents of both of which are hereby incorporated by reference in their entirety.

### TECHNICAL FIELD

The invention relates to the optimization of a numerical control of a machine tool having a tool for machining a workpiece.

### BACKGROUND

Machine tools are known from EP 3 720 651 A1 that can, for example, carry out machinings on a workpiece using a tool. In addition, the use of numerical control (NC) has been known for many decades. With numerical control, machines are controlled by the machine reading control commands that are stored as code on a data carrier. Initially, punched tape or punched cards were used as data carriers. The control commands are converted into work or movement sequences. By providing different code lists on different data carriers or files, a numerically controlled machine can be adapted to different machining sequences, e.g. a different workpiece. Computers have been used for control since around 1980, which is known as CNC (computerized numerical control). The sequences are currently stored in standardized data structures, for example in accordance with DIN 66025/ISO 6983 in the so-called G-code. This allows machine tools to use control technology to automatically produce workpieces with high precision, even for complex shapes.

In the standard process of creating a (C)NC program for component production, various sequences of so-called G-codes are implemented. A distinction is made between rapid feeds for positioning axes and milling feeds for active machining. These differ primarily in terms of speed. In order to be able to operate the tool to be used safely, a start-up position is selected, which is approached at a higher speed before switching to the active machining speed. The start-up position is characterized by a safety distance from the workpiece. The choice of the size of this safety distance depends on geometric conditions (e.g. fluctuations in the component geometry, tool geometry, clamping tolerances of the workpiece) and also partly on the experience of the person programming the G-code and their lack of knowledge of the machine functionality and geometry.

A disadvantage of the state of the art is that current methods have efficiency deficiencies. Specifically, selecting a safety distance that is too large means that potential is lost in terms of cycle time and therefore throughput, while a distance that is too small can lead to damage of the tool.

### SUMMARY

The object of the present invention is thus to overcome the disadvantages of the prior art. A method for optimizing a numerical control of a machine tool and a device for executing the method, a machine tool for machining workpieces by executing the method, a computer program product, a computer-readable medium, a method for machining workpieces, a method for training a neural network and the data structure of a trained neural network are provided.

This object is achieved by the subject matter according to the independent claim(s). Advantageous further embodiments can be found in the dependent claim(s).

In the context of the machine tools described here, for example, a machining can include the following phases: start-up, approach, tool entry, working phase, tool exit and departure. However, the classification can also be made differently. The terms are merely used as examples to refer to the respective parts of a machining.

The advantage here is that the entry point in time (and exit point in time) of the tool in the material is determined and thus the actual idle time can be calculated. By aggregating this value over several machinings (i.e. several workpieces), the splitting resulting from the natural geometric fluctuations is calculated. By determining the minimum value, the optimum is calculated to reduce the cycle time while ensuring safe operation of the tool.

The method can be used for optimization before series production and during the ongoing process. The economic benefit results from the fact that the cycle time of component production is reduced and the throughput rate is increased.

The project that led to this application has received funding from the European Union's Horizon 2020 research and innovation program under grant agreement No 857191.

According to a first embodiment, a method according to the invention for optimizing a numerical control of a machine tool having a tool for machining a workpiece comprises obtaining numerical tool information with respect to a machining, the tool information comprising a spindle torque of the tool and axis positions of the tool for each time of the machining. The method further comprises determining, by a trained neural network, timing information based on the obtained tool information. The timing information comprises a point in time of tool entry into the workpiece and a point in time of tool exit from the workpiece. A set of path information for machining is then generated from the determined points in time and the tool information. Such a set of path information comprises a travel path of the tool, which comprises the phases: approach, tool entry, working phase and tool exit, and a distance between the tool and the workpiece before the approach phase. A minimum distance between the tool and the workpiece before the approach phase is then determined for the next machining from several sets of path information from several previous machinings.

The method according to the invention allows an optimum minimum distance to be determined, which improves the cycle time and thus the throughput. In addition, damage to the tool is avoided.

The process can be further improved if the tool information also includes the spindle speed of the tool.

By taking the spindle speed into account, the determination of timing information by the neural network can be improved.

The numerical tool information can be received from the numerical control. Alternatively or additionally, numerical tool information can be read from a storage, a database or a data carrier and taken into account.

It has been shown that the use of any additional, so-called historical, data from previous machining improves the accuracy of the neural network in the inference.

The determination of the timing information by the neural network can also be optimized if the tool information is cleaned up by removing information that is irrelevant for determining the minimum distance before the determination.

It has been shown that some data sets contain data that is irrelevant for determining the minimum distance. By cleaning up the data before inference, the determination of the timing information can be accelerated.

Furthermore, it may be useful to determine not only the minimum distance before the approach, but also before or during the start-up, during or after the approach, and/or during or after the departure. These can also be determined from several sets of path information from several previous operations for the next operation.

By ensuring a minimum distance in the corresponding phases, damage to the tool and the workpiece due to unwanted contact can also be avoided.

It can prove advantageous to use the current machining to re-train the trained neural network. The acquired, generated and determined information, or a selection thereof, can be used for re-training.

Retraining through the current machining has a minor influence on the accuracy of the neural network. However, continued re-training will steadily improve the neural network over time. The current machining can also be saved first, and after accumulating a certain amount of data from machinings, e.g. at the end of a day or a week, etc., the neural network can be re-trained with the saved data. This can be carried out unsupervised overnight or at the weekend, for example. However, supervised re-training is also possible.

For the determination of minimum distances, one or more of the geometries of workpieces before machining, geometries of workpieces after machining, geometry of the tool, clamping tolerances of the workpieces and tool wear can also be taken into account.

It has been shown that in some cases, taking this data into account also leads to an improvement, and thus unintentional damage can be avoided by preventing unwanted collisions, and efficiency can be increased because the travel paths, or trajectories, can be planned more optimally.

According to a further embodiment of the invention, a device comprising at least one computing unit, at least one storage apparatus and a trained neural network is provided, wherein the device is adapted to perform the steps of a method according to the invention. This device can be part of a machine tool or can also be independent.

According to a further embodiment of the invention, a machine tool is provided with means suitable for carrying out the steps of a method according to the invention and for machining workpieces, taking into account the determined minimum distances during machining.

According to a further embodiment of the invention, a computer program product comprising commands which, when the program is executed by a computer, cause the computer to perform a method according to the invention. The computer program product may be stored on a computer-readable medium.

According to a further embodiment of the invention, a method for machining a workpiece is provided by the machine tool according to the invention.

According to a further embodiment of the invention, a method for training a neural network is provided. A plurality of training data sets is obtained, each training data set comprising numerical tool information with respect to a machining and comprising a spindle torque of a tool of a machine tool in the form of a time series for each point in time of the machining. The training data sets are then segmented, whereby the corresponding time series of each training data set is divided into at least three areas by marking the points in time for a tool entry and for a tool exit. After padding each training data set, whereby fill data is added at the beginning and end of each time series, the neural network is trained with the training data sets.

According to a further embodiment of the invention, a data structure of a neural network is provided, which is configured to determine the points in time of tool entry and tool exit for machining a workpiece by a tool of a machine tool on the basis of spindle torque data of the tool learned in the data structure from previous machinings.

The embodiments show possible embodiment variants, whereby the invention is not limited to the specifically illustrated embodiment variants thereof, but rather combinations of the individual embodiment variants with one another are also possible.

For a better understanding of the invention, it is explained in more detail with the aid of the following figures.

### BRIEF DESCRIPTION OF THE DRAWINGS

The figures show a simplified, schematic representation:

FIG. 1 shows a machine tool having a tool for machining a workpiece according to one embodiment;

FIG. 2 shows schematic flow diagrams according to embodiments;

FIG. 3 shows an exemplary structure of the neural network according to one embodiment, and

FIG. 4 schematically shows the results of the neural network according to the embodiment.

### DETAILED DESCRIPTION

By way of introduction, it should be noted that in the differently described embodiments, the same parts are provided with the same reference signs or the same component designations, whereby the disclosures contained in the entire description can be transferred analogously to the same parts with the same reference signs or the same component designations. The position details selected in the description, such as top, bottom, side, etc., also refer to the directly described and illustrated figure and these position details are to be transferred analogously to the new position if the position is changed.

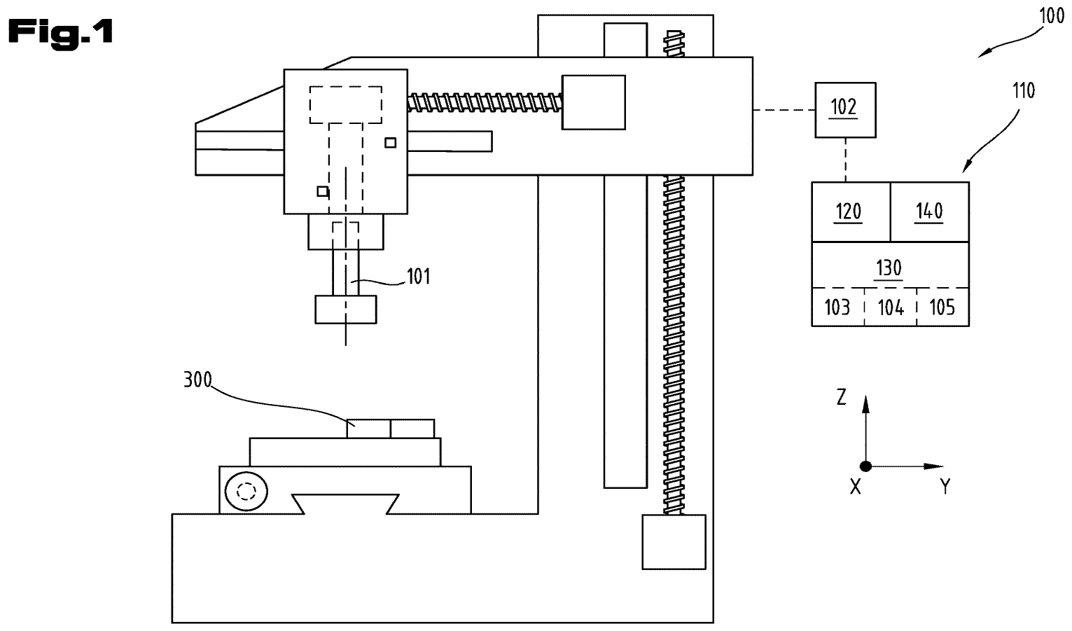

FIG. 1 shows a machine tool 100 with a tool 101. This tool can be a milling head, a drill, a brush or another cutting tool that engages in a workpiece 300 to remove material. The tool is controlled by a numerical control 102 and driven in rotation by a spindle. The machine tool may comprise a computing device 110. The computing device may alternatively be a stand-alone device.

First, the basic mode of operation of the presented machine tool 100 is explained. Machining of a workpiece 300 by a tool 101 has several sections or (machining) phases.

First, the tool 101 is moved into the vicinity of the workpiece 300. This is the approach or rapid traverse. The start-up can be carried out at a high speed (e.g. 500 mm/s). During the start-up, the tool 101 can still be operated in an idle state. A drill, a saw or a milling cutter would then not yet be rotating and would therefore not yet be able to process or remove any material. However, the tool 101 can also already be operated in the machining mode. The approach ends when a predetermined minimum distance to the position at which the workpiece 300 is expected is reached. The actual distance at this point may differ for each workpiece 300, as the workpieces 300 may not correspond exactly to each other and there may be production or clamping tolerances. A workpiece 300 could also be contaminated or it could not be positioned exactly. During the start-up, the existing geometries are taken into account, i.e. the tool 101 is moved to the workpiece 300 in such a way that the desired position relative to the workpiece 300 is achieved. The desired position can be defined by one, two or three axes in space. If a workpiece is to be cut completely through by a relatively large saw, one axis may be sufficient. Two axes may be sufficient for drilling a hole at one point on a workpiece, and three axes may be necessary for milling in an already formed body. The start-up also takes into account that a collision is not possible during the start-up and that the previously defined minimum distance is maintained.

The term distance or minimum distance generally always refers to the smallest distance that the tool 101 has to the workpiece 300 at any point.

If the specified minimum distance has been reached and the tool 101 is not yet in operation, it can now be switched on. The tool 101 is then approached slowly, i.e. at the planned machining speed (e.g. 36 mm/s), to the workpiece 300. This is the approach. This is done so that when the tool 101 actually comes into contact with the workpiece 300, i.e. when the tool enters, machining already begins. In addition, the slow speed has the advantage that machining can take place with the desired quality. A speed that is too fast could possibly lead to excessive force at the start of material removal and thus to an irregular movement of the tool 101, so-called chattering, whereby undesirable removal, so-called “chatter marks”, can impair the quality. In addition, the tool 101 could be damaged by excessive force when entering the tool.

The working phase begins after tool entry. For a drill, this would be the drilling and for a milling machine this would be the milling feed or material removal. The working phase ends with the tool exit.

This is followed by the departure, which can be performed more quickly again, saving time in the overall process. The departure ends as soon as the tool 101 has reached the desired end position. The end position can be a rest position or also a position outside the workpiece 300, so that, for example, the workpiece 300 can be removed and the next workpiece 300 can be provided. It is also possible that a movable conveyor device, on which the workpieces 300 are arranged, should continue to move, in which case the tool 101 is brought into a position where this is possible.

During the departure, the existing geometries are also taken into account again, i.e. the tool 101 is moved away from the workpiece 300 in such a way that a collision is not possible.

In one embodiment, the departure is carried out directly as a start-up for the next machining. This is the case, for example, if several holes are to be drilled in a workpiece 300. The machining of a workpiece 300 can therefore comprise several machinings.

Returning to FIG. 1, the computing device 110 is now described in more detail. Accordingly, all or some of the elements of the computing device 110 described below can also be part of the machine tool 100. The computing device 110, or the machine tool 100, can accordingly comprise a computing unit 120. This is also called a processor or CPU (central machining unit). The computing unit 120 may also comprise a plurality of processors, one or more of which may also be supporting processors, such as graphics machining units (GPUs). Processors from other computers can also be used, i.e. the machining is outsourced.

The (computing) device 110 may further comprise a storage apparatus 130 on which input, output, intermediate result and/or program data may be stored. Control data of the numerical control can also be stored on the storage apparatus. The storage apparatus 130 may relate to a storage 103, a database 104 and/or a data carrier 105, the latter being connected to the computing device 110 or the machine tool 100 via a corresponding interface, such as a disk drive or a wired or wireless interface.

The device 110 or the machine tool 100 further comprises a trained neural network 140, or NN for short. The NN 140 can be designed in various-known-embodiments. For the purpose of explaining the present invention, one is described in more detail as an example, but common alternatives would also be conceivable, such as an autoencoder or a convolutional neural network (CNN)

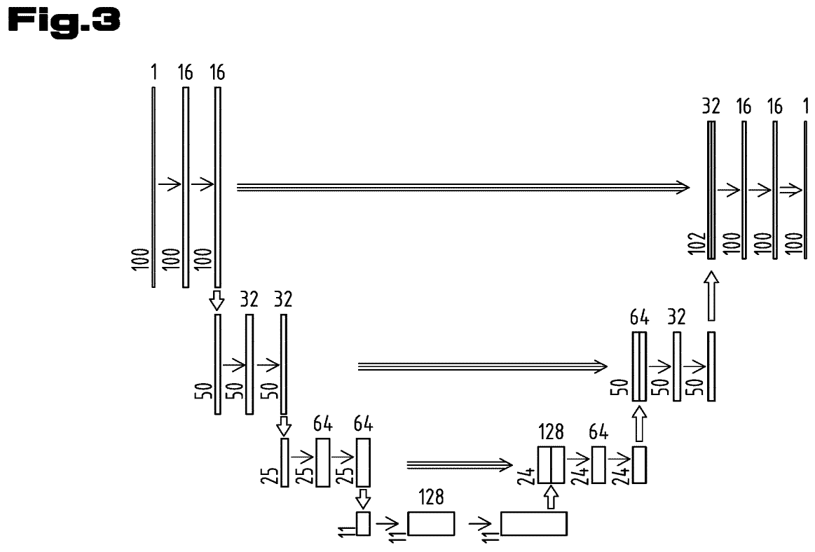

The example NN described is formed according to the U-Net architecture, as shown in FIG. 3. The features and functionality of the U-Net architecture are generally known, so we will not go into all the details. If the U-Net architecture is used, the NN can extract the features for the calculation itself using the convolution filters and can learn them. This structure realizes (image) segmentation. According to the present invention, a time series is segmented, which is interpreted as a single-line image for the NN. After a convolution, a batch normalization is performed with the purpose of making the layers faster and more stable by re-centering and re-scaling. Finally, the neurons are activated with an activation function, for example with a rectified linear activation function (ReLU). After folding and normalizing twice, the distinctive features are reused for the next layers using max-pool layers so that the number of parameters is not too large.

The input to the trained NN 140 is then according to the size T×1, where T is the length of the time series, i.e. the number of measurement data at the respective points in time (timestamps). This length is variable and does not have to be known due to the chosen architecture, because the U-Net (like the CNN) only uses convolutions, transposed convolutions, max-pooling, normalization and activation function, none of which are tied to a fixed input variable. This means that the size of the input is variable and does not have to be fixed. This means that machinings of different lengths can be executed.

To calculate the convolution, the size of the kernel and the parameters dilation, padding and stride (step size) must be defined. For the U-Net in the experiment, the size of the kernel was set to 5, the dilation to 7, the padding to 14 and the stride to 1. By selecting these parameters, the output variable of the time series after the calculations in this level is the same as the input variable of the time series. In the lower levels, the input size of the so-called feature maps remains the same. Normalization does not change this length either. However, the pooling layer reduces the input size, depending on the parameters selected. If kernel size is selected as 2, padding as 0, dilation as 1 and stride as 2, the input size N changes with each pooling layer according to the calculation

$$⌊ \frac{N - 2}{2} + 1 ⌋ .$$

This results in compression in the lower layers, which is resolved again with the decoding and the time series has its length T again at the end.

On the decoding side, the parameters for the convolution are selected in the same way; for the transposed convolution, the kernel size is set to 5, the stride to 2, the dilation to 1, the padding to 1 and a final output padding also to 1. This results in an output size of 2×N+2. This output layer is merged with the characteristics of the corresponding encoding as input and is then set to the same size (the so-called copy and crop process) and ultimately leads back to the output variable T. The parameters are not explained in detail here, as they are known to a specialist and can be found in standard literature. The choice of parameters was determined in tests to find the best accuracy for the available data and can be adjusted accordingly.

In the following, with reference to FIG. 3, the mode of operation in the inference is explained using an example constellation. The input data, i.e. the time series with the torque values, is interpreted as an image of size 100×1.

The network architecture consists of a contraction path (left-hand side) and an expanding path (right-hand side). The contraction path follows the typical architecture of a convolutional network. It consists of the repeated application of two 5×1 convolutions (convolutions without padding, shown in FIG. 3 by simple arrows -> to the right), each followed by a ReLU and a 2×1 max-pooling operation (shown in FIG. 3 by arrows pointing down) with stride 2 for downsampling. At each downsampling step, the number of feature channels doubles. Each step in the expansive path consists of an upsampling of the feature map, followed by a 5×1 convolution (upward convolution, shown by upward arrows in FIG. 3), which halves the number of feature channels, a concatenation with the correspondingly cropped feature map from the contraction path and two 5×1 convolutions (again shown by simple arrows -> to the right in FIG. 3), each followed by a ReLU.

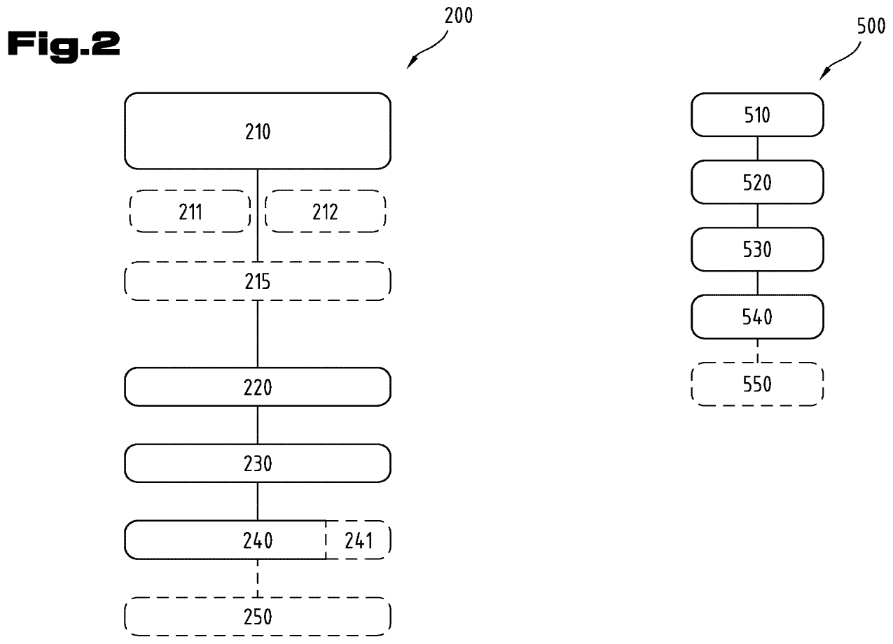

Crop and copy (shown in FIG. 3 by triple arrows≡> to the right) is necessary due to the loss of edge pixels in each convolution. On the last layer, a 1×1 convolution (shown by a double arrow => to the right in FIG. 3) is used to map each feature vector with 16 components to the desired number of classes. In total, the network has 18 convolutional layers. To enable seamless tiling of the output segmentation map (see FIG. 2), it is important to size the input tiles such that all 5×1 max pooling operations are applied to a layer with a uniform x and y size.

However, due to the compression in the selected constellation, the input data must have a minimum size of 32 timestamps before the first layer. With regard to the intervals between the points in time (timestamps), there are no mandatory circumstances, but it has been found that an interval of 0.006 seconds between the measurement points leads to good results. Therefore, in this case, a time series of at least 0.186 seconds in length would be required, which corresponds to 32 measurement points with 31 intervals of 0.006 seconds each.

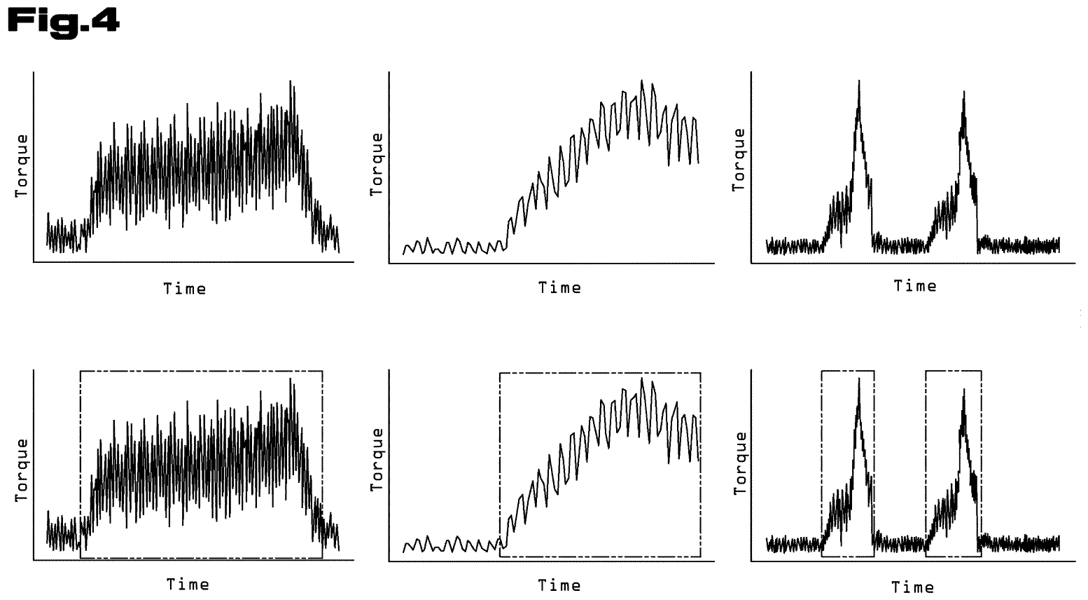

FIG. 4 shows exemplary results of the NN 140. 3 different measurements of torque values over time can be seen at the top, and the evaluation generated by the NN 140 can be seen in the lower figures. The areas in which the tool was determined to be “in the workpiece” are marked with a dashed frame. The feature to be regarded as the result after passing through the NN 140 indicates in binary form, i.e. for each torque measurement value the classification to 0 or 1 is made, whether the tool is outside the workpiece (value 0) or whether the tool is inside the workpiece (value 1). Thus, the transitions 0 to 1 and 1 to 0 can be determined as tool entry and tool exit, respectively, and are defined by the boundary of the dashed area, i.e. the dashed line, in FIG. 4

As mentioned above, an autoencoder architecture can also be used as an alternative, which reduces the size of the information entered. Decoding is then performed and the linear feature representation is learned, which gradually increases the size of the grid. At the end of this architecture, the output size corresponds to the input size. A well-known advantage of the autoencoder architecture is that the initial size can be retained. The U-Net architecture also has this advantage. However, with the autoencoder, the input is compressed linearly so that not all features can be transferred.

In contrast, the U-Net architecture is more suitable, as the U-shape means that the deconvolution takes place on the decoder side, which avoids the bottleneck problem that occurs with an auto-encoder architecture and thus the loss of features. Specifically, the neural network is given the features of the associated encoding as input (also known as “copy and crop”) for each deconvolution. These are represented in FIG. 3 by triple arrows≡> to the right. This allows the NN to use features that it learns during encoding (also known as folding) for decoding (also known as unfolding), which distinguishes it from the CNN. The U-Net architecture therefore has an advantage over the autoencoder and the CNN, as it significantly improves learning. The use of the U-Net architecture is particularly advantageous, as it is known that it can be trained with relatively little training data. Therefore, better results can be achieved with the U-Net architecture with less training data than with other neural network architectures, for example also than with an autoencoder, which often require several thousand training data.

The NN 140 used in the embodiments must first be trained. This is done by a method 500 for training the NN 140. For training, the data of already performed machinings is first obtained in step 510. Obtaining 510 can be realized by generating the corresponding training data sets, for example by repeatedly performing the machining to be trained, or also by loading data of previous machinings (i.e. repetitions of the machining) from a data storage on which they were previously stored. In other words, if the respective operation has already been carried out several times, this data may already be available in saved form. If the corresponding training data is not available, it must first be generated by repeating the corresponding operation.

Specifically, the training is carried out as supervised training, in which both the input data and the expected output data are available. For the respective machining, for example for drilling/milling a hole in a workpiece, a large amount of data must be available for precisely this drilling/milling operation. Each of these machinings (i.e. drilling or milling) comprises the approach, tool entry, working phase and tool exit phases. Parts of approach and departure can also be included. However, these are not used for training and can be filtered out with control information if they are present.

It has proven to be sufficient to carry out a few hundred or more processes or to use their data. If more data sets are used, more data sets need to be processed, but the result allows for better training and therefore higher accuracy in the inference. These are first processed by expert personnel, for which, for example, annotation software can be used to annotate or segment the corresponding time series.

For segmentation, as step 520, for example, the areas are stored as 0 (outside the material, i.e. workpiece 300) and 1 (inside the material, i.e. during material removal in the workpiece 300) at each point in time. The classification into these classes, 0 and 1, is carried out on the basis of the torque, whereby the torque values each have a significantly different pattern depending on whether the tool is idle (outside the workpiece 300, i.e. before and after the working phase or machining), or whether an entry or exit into or out of the workpiece 300 takes place. The classification may also include further sub-areas, for example the above-mentioned phases of a machining. In addition, the designation of the areas with 0 and 1 is to be understood merely as an example.

Subsequently, in step 530, each training data set is extended at its edges by unimportant data, for example zero or mean values, as the edge areas are lost or ignored by the convolution. This is called padding. In the time series, such padding data is added at the beginning and end of each time series. Experiments have shown that for the available data 20 such padding data at the beginning and end provide good results.

The NN 140 can then be trained, for example, with a train-test split of 80% and 20% in step 540. The percentage splitting should only be seen as an example. Other values are also possible, but as a rule relatively less data is used for the training test phase described in more detail below than for training. With the above-mentioned 80% to 20% splitting, 80% of the available data is used for training (the so-called training set), while the remaining 20% of the data is used for testing (the so-called test set) after each learning process. After each training run, the error between the output of the network and the expected output, the so-called loss, is calculated on both the training set and the test set. This process is used to monitor the training. The error for the training set becomes smaller as the training progresses because the network is designed to optimize the output based on the patterns contained in the training data. As the network learns the features that are actually relevant, the error on the test set decreases. As soon as the error of the test set increases and the error of the training set continues to decrease, this is referred to as overfitting and the training can be terminated. Experiments have shown that training with a batch size of 100 samples per training process works well. Batch sizes between 50 and 200 samples are more common. In an exemplary experiment, for example, no significant improvement in the loss could be determined after 43 epochs and the training was then terminated. The loss is calculated using a metric such as Binary Cross Entropy, Dice Coefficient or Mean Square Error. An optimization algorithm is then used for the optimization. Examples of such optimization algorithms include the Adam algorithm or the Stochastic Gradient Optimizer. Furthermore, an initial learning rate of 0.001 can be defined, which can be multiplied by a factor of 0.1 after every 10 updates, for example. The parameters batch size, epochs, learning rate and scaling factor are so-called hyperparameters and can differ depending on the specific data set; the specified parameters have led to the best result in terms of accuracy in tests. In order to find the best possible combination of parameters, tests are carried out with different combinations and the combination that leads to the best result is selected.

The trained NN 140 can then be used to optimize a machine tool 100 with a tool 101, as explained below with reference to FIG. 2.

Here, in the method 200, numerical tool information with respect to a machining is first obtained in step 210. In this context, as already mentioned above, a machining is to be understood, for example, as a drilling or milling operation, which in each case comprises the start-up, approach, tool entry, working phase, tool exit and departure phases. However, it is not necessary to obtain information for all phases. In particular, information for the approach and departure phases is not necessary.

The tool information comprises at least the torque, for example a spindle torque, of the drive of the tool 101 and the axis positions of the tool 101, which uniquely determine the respective position of the tool in three dimensions at the respective point in time. Further information about the tool and the machining process can be included. For example, the material of the workpiece, a serial number of the tool or other elements involved in the machining process or a rotational speed, e.g. the spindle speed, or another key figure or measured values with respect to the drive of the tool 101.

In a step 220, the NN 140 trained as described above then acquires timing information from the tool information received for this machining. This timing information comprises the point in time at which the tool enters the workpiece and the point in time at which the tool exits the workpiece.

As the NN 140 has learned, the time series is linked to the torques and the corresponding points in time are classified so that the NN 140 can recognize the entry and exit points.

If the point in time of tool entry and the point in time of tool exit are known, the time duration occupied by the working phase is also automatically known, as this is defined by tool entry and exit.

Subsequently, in a step 230, a set of path information is generated from the determined points in time and the tool information. This path information essentially reflects the path that the tool 101 has traveled during the one machining. The path information comprises the travel path of the tool and the distance between the tool and the workpiece before the approach phase. The travel path comprises the approach, tool entry, working phase and tool exit phases. Start-up and departure can also be included. Additional information can also be derived or calculated from the path information and the tool information. For example, the position of the tool can be determined from the axis positions at any point in time. Since the machining process has already been completed, the distance of the tool 101 to the entry point into the workpiece 300 can also be precisely determined retrospectively.

However, the distance between the tool 101 and the workpiece 300 generally also depends on the manufacturing tolerances of the workpiece. For example, a metal plate may well have a tolerance of several millimeters, so that the distance cannot be determined exactly in advance, which is why the slow approach is necessary in the first place. Although the exact dimensions at the entry point are known after machining due to the point in time of entry, the tolerances at other points are not known.

Therefore, the total distance between the tool and the workpiece other than the entry point can only be determined within the tolerances that are relevant for the machining.

In a step 240, the minimum distance between the tool 101 and the workpiece 300 prior to the approach phase is then determined from multiple sets of path information from multiple previous machinings for the next machining. For this purpose, data of previous machinings, i.e. the distance between the tool 101 and the workpiece 300 generated for previous machinings before the approach phase, is evaluated, and if the distance generated for the current machining is smaller than those of the previous ones, then the minimum distance is increased to the distance of the current machining.

This means that if the minimum distance, which was not sufficient for the current machining because the tool 101 hit the workpiece 300 earlier than expected, then the minimum distance is increased for the next machining.

Regular checks can remove outliers from the data records, for example if a workpiece was deformed, faulty or contaminated, so that they are not taken into account.

As previously mentioned, the data for performing the method can also come from stored data. The data can therefore be received 211 from the numerical control 102, for example directly after a machining. However, data can instead or additionally be loaded or read 212 from a storage 103, from a database 104 or from a data carrier 105.

In one embodiment, the tool information can be cleaned up 215 by preprocessing. For example, before determining the timing information, information that is irrelevant for determining the minimum distance is removed. This can be done, for example, by filtering using a signal filter or frequency filter. Alternatively, points in time, time ranges or machining phases can also be omitted. Here, for example, it is advantageous to only consider the data of those phases in which the workpiece is also being processed. For this purpose, a distinction can be made between the phases of positioning the axes (start-up, approach, departure) and the active advancement of the axes for the working phase. Data in which another, non-machining-related process is running can also be hidden. It would also be possible, for example, to filter out any repositioning phases.

This means that only the data required to determine, generate and/or identify relevant data is forwarded to the neural network.

In addition, the database can be prepared for determination by the neural network using the usual pre-machining steps for neural networks. These include, for example, scaling, padding, etc.

These pre-machining steps can be carried out, for example, by distributing data via a message broker or message bus and using scripts for data pre-machining and calculation by the neural network. This has the advantage that the results are available almost in real time. Alternatively, these can also be provided by a computing unit in a different way. It is also possible to read data from a file and process it iteratively. It is also possible to read out data from a file or a historical storage (e.g. a database containing time series of previous processes and/or simulations). These can then be separated into individual treatments (using the control information) and processed further. Individual processes can also be saved as a file, which means that splitting is no longer necessary and machining can be started immediately—if necessary after appropriate pre-machining for the model, as described above.

Since, as described above, all necessary data is available after the machining, additional minimum distances between the tool 101 and the workpiece 300 can also be determined in a further step 241 before or during the start-up, during or after the approach, or during or after the departure. As described above in the context of step 240, this also functions from several sets of path information from several previous machinings and, if necessary, determines the corresponding minimum distance for the next machining in each case.

For example, it can be determined that the tool 101 came relatively close to a protruding part of the workpiece during the approach. To make a possible collision even less likely during future machinings, the corresponding minimum distance can be increased and taken into account when planning the path for the next machining.

When determining minimum distances according to steps 240 or 241, further information can also be taken into account. For example, the geometry of the workpieces before and/or after machining may be taken into account. Here, an example could be that a hole needs to be placed in a hemispherical workpiece. Since the geometry of the hemispherical shape is known, it is possible to calculate the distance that the tool has or must have to the workpiece on its path. The geometries before and after machining can differ, as material may be removed so that the workpiece 300 is shaped differently after machining. The geometry of the tool 101 can also be taken into account, as can the clamping tolerances of the workpieces 300 and the tool wear.

The NN 140 may be re-trained in step 250, if necessary. As set forth above, the current machining, or multiple machinings in which the trained NN 140 was used, may be used to re-train the trained neural network 140. Here, the acquired, generated and determined information, or a selection thereof, can be used for re-training. For this purpose, these are checked for correctness before re-training and corrected if necessary. Incorrect labeling (i.e. the designation of an area with an incorrect designation (label)) could lead to a deterioration of the model, i.e. the NN 140.

In general, re-training 250 is considered if the accuracy of the model deteriorates. This can happen, for example, if the data changes due to previously unknown influences, e.g. wear of the spindle or tool, or changes to the mechanics in other machine components. These influences may not be included in the data previously used for training. By re-training, the data set can be enlarged and the accuracy of the model can be improved again.

The re-training 250 can be seen here as a resumption of the training method 500 or also after practical use as an additional step of the inference 200.

In one embodiment, a device 110 is provided comprising at least one computing unit 120, at least one storage apparatus 130 and a trained neural network 140, wherein the device 110 is adapted to perform the steps of the method 200 set forth above. Such a device 110 is thus programmed according to the conditions of machining, and comprises the trained NN 140 according to the invention. The device 110 may have the configuration of a computer which, without machine tool 100, reads the data of the previous and current machining from its storage apparatus 130 and determines the corresponding distances. The storage apparatus 130 may refer to a storage 103, a database 104 and/or a data carrier 105, the latter being connected to the computing device 110 in a corresponding interface, such as a disk drive, or a wired or wireless interface.

Alternatively, the device 110 is part of the machine tool 100, in which case there is the additional possibility that the device receives the data of the current machining directly from the numerical control 102.

The machine tool 100 may also itself comprise corresponding elements which enable it to carry out the method 200 as set out above. Also in this case, there is the additional possibility that the data of the current machining are obtained directly from the numerical control 102. The machine tool 100 is then set up to machine workpieces 300, taking into account the determined minimum distances during machining.

Another embodiment is a computer program product comprising commands that, when the program is executed by a computer, cause the computer to perform one of the methods 200 or 500 set forth above.

Another embodiment is a computer-readable medium on which the computer program product is stored.

Another embodiment is a method 400 for machining a workpiece 300 by the previously described machine tool 100.

The embodiment examples show possible embodiment variants, whereby it should be noted at this point that the invention is not limited to the specifically illustrated embodiment variants thereof, but rather various combinations of the individual embodiment variants with one another are also possible and this variation possibility lies within the skill of the person skilled in the art in this technical field due to the teaching on technical action by the present invention.

The scope of protection is determined by the claims. However, the description and the drawings must be used to interpret the claims. Individual features or combinations of features from the various embodiments shown and described may constitute independent inventive solutions. The object underlying the independent inventive solutions can be taken from the description.

All indications of value ranges in the present description are to be understood as including any and all subranges thereof, e.g. the indication 1 to 10 is to be understood as including all subranges, starting from the lower limit 1 and the upper limit 10, i.e. all subranges start with a lower limit of 1 or greater and end with an upper limit of 10 or less, e.g. 1 to 1.7, or 3.2 to 8.1, or 5.5 to 10.

Finally, for the sake of order, it should be noted that some elements have been shown out of scale and/or enlarged and/or reduced in size to make the layout easier to understand.

1. A computer-implemented method for optimizing a numerical control of a machine tool having a tool for machining a workpiece, comprising:
obtaining numerical tool information with respect to a machining, the tool information including a spindle torque of the tool and axis positions of the tool for each point in time of the machining;
acquiring by a trained neural network timing information, the timing information including a point in time of tool entry into the workpiece and a point in time of tool exit from the workpiece, based on the obtained tool information;
generating a set of path information for machining from the determined points in time and the tool information, the set of path information including:
a travel path of the tool, which includes a plurality of phases, the plurality of phases including an approach phase, a tool entry phase, a working phase, and a tool exit phase, and
a distance between the tool and the workpiece before the approach phase; and
determining a minimum distance between the tool and the workpiece before the approach phase from a plurality of sets of path information of a plurality of previous machinings for a next machining.

2. The method according to claim 1, wherein the tool information further includes a spindle speed of the tool.

3. The method according to claim 1, wherein obtaining the numerical tool information includes receiving the numerical tool information from the numerical control.

4. The method according to claim 1, further comprising, prior to acquiring the timing information, cleaning the tool information via removing information irrelevant to the determination of the minimum distance.

5. The method according to claim 1, further comprising determining at least one minimum distance between the tool and the workpiece at least one of before a start-up, during the start-up, during the approach phase, after the approach phase, during a departure, and after the departure from the plurality of sets of path information of the plurality of previous machinings for the next machining.

6. The method according to claim 1, wherein, when determining the minimum distance, at least one of geometries of workpieces before machining, geometries of workpieces after machining, a geometry of the tool, clamping tolerances of workpieces, and tool wear are taken into account.

7. A method for training a neural network, comprising:
obtaining a plurality of training data sets that each include i) numerical tool information with respect to a machining and ii) a spindle torque of a tool of a machine tool in the form of a time series for each point in time of the machining;
segmenting each training data set of the plurality of training data sets, whereby the corresponding time series is divided into at least three areas via marking a point in time for a tool entry and a point in time for a tool exit;
padding of each training data set of the plurality of training data sets, whereby fill data is added at a beginning and an end of the corresponding time series; and
training the neural network with the plurality of training data sets.

8. The method according to claim 7, further comprising re-training the trained neural network using at least one of acquired information, generated information, and determined information.

9. A computer-implemented data structure of a neural network trained according to claim 7, wherein the data structure is configured to determine a point in time of tool entry and a point in time of tool exit for a machining on a workpiece by a tool of a machine tool based on spindle torque data of the tool learned in the data structure from a plurality of previous machinings.

10. A device, comprising at least one computing unit, at least one storage apparatus, and a neural network, wherein the device is configured to perform the method according to claim 1.

11. A machine tool, comprising a device configured to perform the method according to claim 1 and to machine workpieces taking into account the determined minimum distance during machining.

12. A computer program product, comprising a plurality of commands which, when executed by a computer, cause the computer to execute the method according to claim 1.

13. A computer-readable medium, comprising the computer program product according to claim 12.

14. A method for machining a workpiece by the machine tool according to claim 11.

15. A machine tool, comprising the device according to claim 10 and a tool configured to machine workpieces taking into account the minimum distance determined by the device.

16. The method according to claim 1, wherein obtaining the numerical tool information includes reading the numerical tool information from at least one of a storage, a database, and a data carrier.

17. The method according to claim 1, wherein the tool is a material removal tool that engages the workpiece to remove material from the workpiece.

18. The method according to claim 17, wherein the removal tool is at least one of a milling head, a drill, a brush, and a cutting tool.

19. The method according to claim 1, wherein:
the plurality of phases of the travel path of the tool further includes a start-up phase and a departure phase;
the start-up phase, the approach phase, the tool entry phase, the working phase, the tool exit phase, and the departure phase of the travel path of the tool occur sequentially one after another in that order;
the start-up phase is a first portion of the travel path of the tool during which the tool moves to a minimum distance position at which the tool is disposed the determined minimum distance from the workpiece;
the approach phase is a second portion of the travel path of the tool during which the tool moves from the minimum distance position to contact the workpiece;
the tool entry phase is a third portion of the travel path of the tool during which the tool enters the workpiece;
the working phase is a fourth portion of the travel path of the tool during which the tool machines the workpiece;
the tool exit phase is a fifth portion of the travel path of the tool during which the tool exits the workpiece; and
the departure phase is a sixth portion of the travel path of the tool during which the tool moves to an end position disposed outside of the workpiece.

20. The method according to claim 19, wherein:
the tool is moved at a machining speed during the approach phase, the tool entry phase, and the working phase of the travel path of the tool; and
the tool is moved at a speed that is faster than the machining speed during at least one of the start-up phase and the departure phase of the travel path of the tool.
